(19) United States
(12) Patent Application Publication
(10) Pub. No.: US 2026/0210177 A1
(43) Pub. Date: Jul. 23, 2026

(54) RESET STRUCTURE FOR ROLLER BLIND, ROLLER BLIND FRAME, AND ROLLER BLIND DEVICE

(71) Applicant: NINGBO WOHOME AUTO SUPPLIES CO., LTD., Ningbo City (CN)

(72) Inventor: Haifeng Wang, Ningbo City (CN)

(21) Appl. No.: 19/566,931

(22) Filed: Mar. 13, 2026

(30) Foreign Application Priority Data
Dec. 1, 2025 (CN) 202522550694.2

(51) Int. Cl. E06B 9/42; E06B 9/60

(52) U.S. Cl. CPC E06B 9/42; E06B 9/60

(57) ABSTRACT

A reset structure for roller blind, a roller blind frame, and a roller blind device. The reset structure for roller blind includes a first mounting structure, a second mounting structure, and a reset component; the reset component includes a series connection members and b reset coil springs. Through series connection of the reset coil springs to increase an angle of relative rotation between the first mounting structure and the second mounting structure, the reset structure for roller blind, the roller blind frame, and the roller blind device are adapted to blind fabrics with different pull-down strokes.

### TECHNICAL FIELD

The present invention relates to the field of roller blind structures, and specifically relates to a reset structure for roller blind, a roller blind frame, and a roller blind device.

### BACKGROUND

A cordless roller blind is one of common roller blinds, in which a coil spring is provided between a winding shaft and a mounting bracket, so that pulling a blind fabric downward causes the winding shaft to rotate, and during rotation of the winding shaft, the coil spring undergoes helical deformation to perform accumulating of elastic potential energy. After the blind fabric is released, the coil spring performs releasing of the elastic potential energy to drive the winding shaft to rotate so as to rewind the blind fabric on an outer periphery of the winding shaft.

Problems existing in the prior art are: a single coil spring is usually used in the existing cordless roller blind. Since a maximum torsion angle of the single coil spring is limited, a pull-down stroke of the blind fabric is limited. If a design requirement for the pull-down stroke of the blind fabric exceeds the maximum torsion angle of the coil spring, it is necessary to replace the coil spring with one having a larger maximum torsion angle, resulting in inconvenience in production.

### SUMMARY

In view of shortcomings existing in the prior art, an object of the present invention is to provide a reset structure for roller blind, a roller blind frame, and a roller blind device, which are adapted to blind fabrics with different pull-down strokes by connecting reset coil springs in series to increase an angle of relative rotation between a first mounting structure and a second mounting structure.

To achieve the above objective, the present invention provides the following technical solution:

As a first aspect, a reset structure for roller blind is provided, comprising: a first mounting structure; a second mounting structure, the first mounting structure and the second mounting structure being arranged for relative rotation; and, a reset component, the reset component being used for connecting the first mounting structure and the second mounting structure; the reset component includes a series connection members and b reset coil springs, and the series connection members are arranged for relative rotation relative to the first mounting structure and the second mounting structure, wherein a and b are both positive integers, and a<b; when a=1, at least one of the reset coil springs is used for connecting the first mounting structure and the series connection member, and at least one of the reset coil springs is used for connecting the second mounting structure and the series connection member; when a>1, at least one of the reset coil springs is used for connecting the first mounting structure and one of the series connection members, at least one of the reset coil springs is used for connecting the second mounting structure and another one of the series connection members, and each of the series connection members is connected to at least another one of the series connection members via at least one of the reset coil springs.

The present invention is further configured as: one of the first mounting structure and the second mounting structure is fixedly arranged, and another one is used for being arranged in linkage with a winding shaft; and/or, wherein, b=a+1.

As a second aspect, a roller blind device is provided, comprising: the roller blind frame described above; and, a blind fabric, the blind fabric being mounted on the winding shaft.

By adopting the above technical solution, one of the first mounting structure and the second mounting structure can be kept fixed, while another one is fixedly mounted to the winding shaft, so that at least two of the reset coil springs are arranged in series. That is, when the first mounting structure and the second mounting structure rotate relative to each other by an angle α, at least one of the reset coil springs rotates by an angle α1, and at least another one of the reset coil springs rotates by an angle α2, where α>α1 and α>α2, so that a maximum angle of relative rotation of the first mounting structure relative to the second mounting structure is greater than a maximum torsion angle of any reset coil spring. By the numbers of the reset coil springs and the series connection members, the pull-down stroke of the blind fabric can be increased or decreased without replacing the reset coil springs, which improves adaptability and makes production more convenient.

### BRIEF DESCRIPTION OF THE DRAWINGS

FIG. 1 is an assembly view of Embodiment 1 of the present invention;

FIG. 2 is a sectional view of Embodiment 1 of the present invention;

FIG. 3 is an exploded view of Embodiment 1 of the present invention;

FIG. 4 is an exploded view of structures of relevant parts of a first mounting portion, a reset component, and a second mounting portion in Embodiment 1 of the present invention;

FIG. 5 is a schematic view of a reset coil spring in Embodiment 1 of the present invention;

FIG. 6 is a schematic view of a mounting rod in Embodiment 1 of the present invention;

FIG. 7 is an exploded view of structures of relevant parts of a first mounting frame in Embodiment 1 of the present invention;

FIG. 8 is an assembly view of Embodiment 2 of the present invention;

FIG. 9 is a sectional view of Embodiment 2 of the present invention;

FIG. 10 is an exploded view of Embodiment 2 of the present invention;

FIG. 11 is a schematic view of a second connection insert sleeve in Embodiment 2 of the present invention;

FIG. 12 is an assembly view of Embodiment 3 of the present invention;

FIG. 13 is a sectional view of Embodiment 3 of the present invention;

FIG. 14 is an assembly view of Embodiment 4 of the present invention;

FIG. 15 is a sectional view of Embodiment 4 of the present invention;

FIG. 16 is an assembly view of Embodiment 5 of the present invention;

FIG. 17 is an assembly view of Embodiment 6 of the present invention.

Reference numerals: 1. first mounting structure; 11. first mounting portion; 12. mounting rod; 111. circumferential positioning protrusion; 121. circumferential positioning slot; 2. second mounting structure; 22. second mounting portion; 3. reset component; 31. series connection member; 32. reset coil spring; 313. third mounting portion; 314. fourth mounting portion; 321. inner mounting portion; 322. hook opening; 323. outer mounting portion; 324. hook slot; 41. first hook protrusion; 42. second hook protrusion; 5. first mounting frame; 51. first connection insert sleeve; 52. linkage component; 511. first latching strip; 521. first connection member; 522. second connection member; 523. linkage gear; 5211. first tooth; 5221. second tooth; 6. second mounting frame; 61. second connection insert sleeve; 611. second latching strip; 7. winding shaft; 8. first top rail; 81. first mounting base; 82. second mounting base; 83. top rail cover; 84. regional partition plate; 831. first region; 832. second region; 833. blind fabric opening; 9. blind fabric.

### DETAILED DESCRIPTION OF THE DISCLOSURE

### Embodiment 1

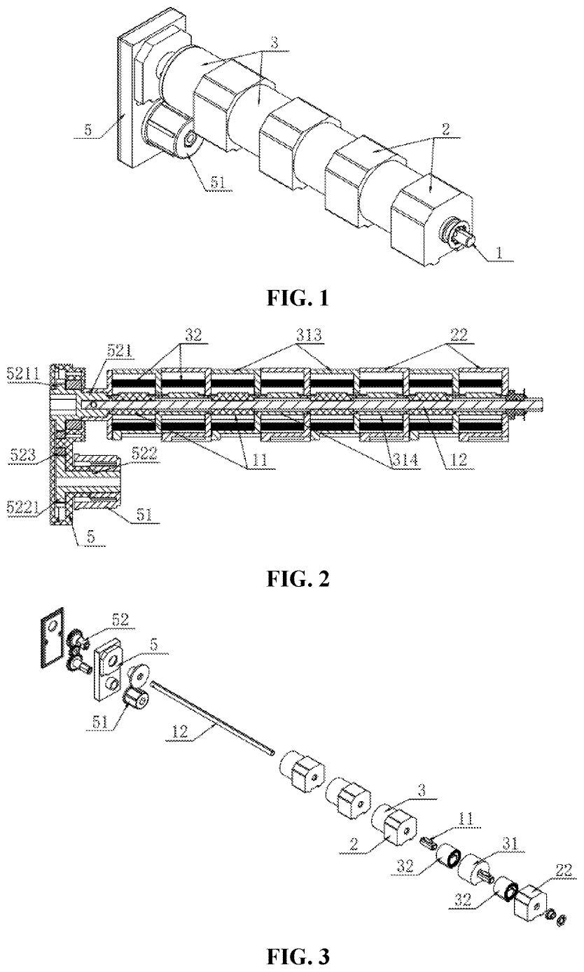

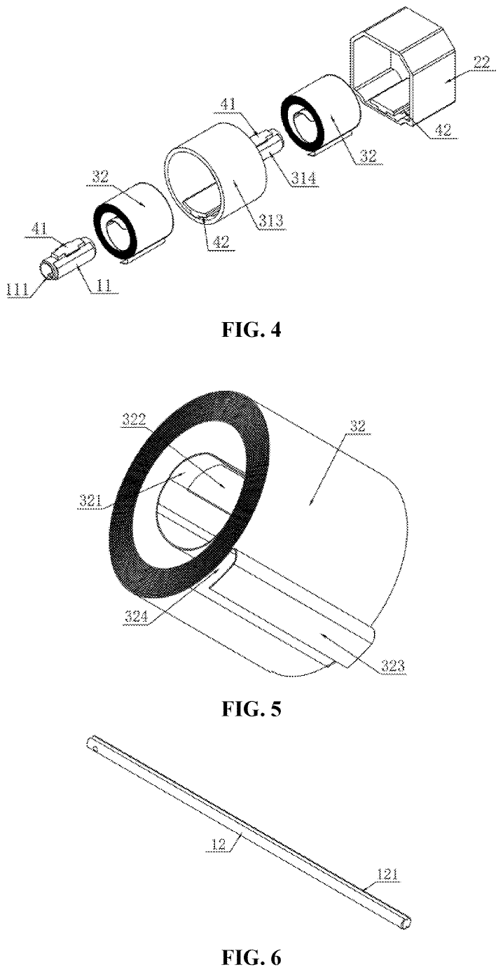

As shown in FIGS. 1 to 7, the present embodiment discloses a reset structure for roller blind, comprising:
a first mounting structure 1;
a second mounting structure 2, the first mounting structure 1 and the second mounting structure 2 being arranged for relative rotation, and an axial direction of rotation being along a left-right direction; and,
a reset component 3, the reset component 3 being used for connecting the first mounting structure 1 and the second mounting structure 2.

Specifically, the reset component 3 includes a series connection members 31 and b reset coil springs 32, the series connection member 31 is arranged for relative rotation relative to the first mounting structure 1 and the second mounting structure 2, wherein a and b are both positive integers, and a is less than b;
when a=1, at least one of the reset coil springs 32 is used for connecting the first mounting structure 1 and the series connection member 31, and at least one of the reset coil springs 32 is used for connecting the second mounting structure 2 and the series connection member 31;
when a>1, at least one of the reset coil springs 32 is used for connecting the first mounting structure 1 and one of the series connection members 31, at least one of the reset coil springs 32 is used for connecting the second mounting structure 2 and another one of the series connection members 31, and each of the series connection members 31 is connected to at least another one of the series connection members 31 via at least one of the reset coil springs 32.

Therefore, one of the first mounting structure 1 and the second mounting structure 2 can be kept fixed, while another one is fixedly mounted to the winding shaft 7, so that at least two of the reset coil springs 32 are arranged in series. That is, when the first mounting structure 1 and the second mounting structure 2 rotate relative to each other by an angle α, at least one of the reset coil springs 32 rotates by an angle α1, and at least another one of the reset coil springs 32 rotates by an angle α2, and satisfying: α>α1 and α>α2, so that a maximum angle of relative rotation of the first mounting structure 1 relative to the second mounting structure 2 is greater than a maximum torsion angle of any reset coil spring 32. By the numbers of the reset coil springs 32 and the series connection members 31, the pull-down stroke of the blind fabric 9 can be increased or decreased without replacing the reset coil springs 32, which improves adaptability and makes production more convenient.

In the present embodiment, the number a of the series connection members 31 in a single set of the reset component 3 is 1, and the number b of the reset coil springs 32 is 2. In other embodiments, different numbers of the series connection members 31 and different numbers of the reset coil springs 32 may also be adopted according to actual requirements.

Wherein, the first mounting structure 1 includes a mounting rod 12 and a first mounting portion 11 provided on the mounting rod 12, wherein an axial direction of the mounting rod 12 is along the left-right direction. The series connection member 31 includes a third mounting portion 313 and a fourth mounting portion 314 which are fixedly and integrally injection-molded. The second mounting structure 2 includes a second mounting portion 22. The first mounting portion 11 is circumferentially fixedly arranged on the mounting rod 12, and the second mounting portion 22 and the fourth mounting portion 314 are both arranged for rotation with the mounting rod 12. The third mounting portion 313 is located at an outer periphery of the first mounting portion 11, one of the reset coil springs 32 is sleeved on the outer periphery of the mounting rod 12, and an inner end of the reset coil spring 32 is connected to the first mounting portion 11, and an outer end of the reset coil spring 32 is connected to the third mounting portion 313 located at the outer periphery of the first mounting portion 11. The second mounting portion 22 is located at an outer periphery of the fourth mounting portion 314, one of the reset coil springs 32 is sleeved on the outer periphery of the mounting rod 12, and the outer end of the reset coil spring 32 is connected to the second mounting portion 22, and the inner end of the reset coil spring 32 is connected to the third mounting portion 313 located at an outer periphery of the second mounting portion 22.

Specifically, the outer periphery of the mounting rod 12 has a cylindrical shape, and a V-shaped circumferential positioning slot 121 is provided on the outer periphery of the mounting rod 12. The circumferential positioning slot 121 is disposed through two axial ends of the mounting rod 12. In addition, the first mounting portion 11, the second mounting portion 22, and the fourth mounting portion 314 are all sleeved on the outer periphery of the mounting rod 12, and the first mounting portion 11 is provided with a circumferential positioning protrusion 111 fitting into the circumferential positioning slot 121, so that the first mounting portion 11 and the mounting rod 12 are circumferentially fixed, while the second mounting portion 22 and the fourth mounting portion 314 are rotatable relative to the mounting rod 12.

Specifically, the first mounting portion 11, the second mounting portion 22, the third mounting portion 313, and the fourth mounting portion 314 all have a tubular shape. An inner diameter of the first mounting portion 11 is adapted to an outer diameter of the mounting rod 12, so that the first mounting portion 11 is sleeved on the outer periphery of the mounting rod 12, and mounting stability is ensured through cooperation between the circumferential positioning protrusion 111 and the circumferential positioning slot 121. An inner diameter of the fourth mounting portion 314 is adapted to the outer diameter of the mounting rod 12, so that the fourth mounting portion 314 is sleeved on the outer periphery of the mounting rod 12 and is rotatable relative to the mounting rod 12. An inner periphery shape of the third mounting portion 313 is significantly larger than an outer periphery shape of the first mounting portion 11, so that the third mounting portion 313 is located at the outer periphery of the first mounting portion 11, and a space for mounting the reset coil spring 32 is formed between the outer periphery of the first mounting portion 11 and the inner periphery of the third mounting portion 313. A side plate is provided on a right side of the fourth mounting portion 314, and a through hole adapted to the outer periphery of the mounting rod 12 is formed on the side plate, so as to be sleeved on the outer periphery of the mounting rod 12 through the side plate and be rotatable relative to the mounting rod 12. An inner periphery shape of the second mounting portion 22 is significantly larger than an outer periphery shape of the fourth mounting portion 314, so that the second mounting portion 22 is located at the outer periphery of the fourth mounting portion 314, and a space for mounting the reset coil spring 32 is formed between the outer periphery of the fourth mounting portion 314 and an inner periphery of the second mounting portion 22.

Wherein, the first mounting portion 11 and the fourth mounting portion 314 are arranged along an axial direction of the mounting rod 12.

Therefore, through relative rotation of the first mounting portion 11 and the second mounting portion 22, the third mounting portion 313 is caused to rotate relative to the first mounting portion 11 to drive the reset coil spring 32 between the first mounting portion 11 and the third mounting portion 313 to twist, and the fourth mounting portion 314 is caused to rotate relative to the second mounting portion 22 to drive the reset coil spring 32 between the second mounting portion 22 and the fourth mounting portion 314 to twist.

In other embodiments, when the number of the series connection members 31 is greater than one piece, the series connection members 31 are arranged along the axial direction of the mounting rod 12, and adjacent series connection members 31 are connected to each other by sleeving the third mounting portion 313 on the fourth mounting portion 314 and providing the reset coil spring 32 between the third mounting portion 313 and the fourth mounting portion 314.

Preferably, when a>1, the numbers of the first mounting portions 11, the second mounting portions 22, and the reset components 3 are the same, and all are a plurality of pieces. In the present embodiment, 4 pieces are specifically adopted. Each of the first mounting portions 11 is arranged along the axial direction of the mounting rod 12, and each of the reset components 3 is used for connecting different ones of the first mounting portions 11 and the second mounting portions 22.

Therefore, each group of the first mounting portion 11, the second mounting portion 22, and the reset component 3 is connected in parallel to the mounting rod 12 respectively, so that a reset acting force generated when the blind fabric 9 is pulled out is larger, improving rewinding capability.

Specifically, an inner mounting portion 321 extending along a winding direction is provided at the inner end of the reset coil spring 32, a hook opening 322 is provided through the inner mounting portion 321 along a thickness direction, and a first hook protrusion 41 inserted into the hook opening 322 is provided on the outer periphery of the first mounting portion 11 and the fourth mounting portion 314. An outer mounting portion 323 extending along a direction opposite to the winding direction is provided at the outer end of the reset coil spring 32, a U-shaped hook slot 324 is provided between the outer mounting portion 323 and the reset coil spring 32, and a second hook protrusion 42 inserted into the hook slot 324 is provided on the inner periphery of the second mounting portion 22 and the third mounting portion 313.

So as to ensure connection stability between the reset coil spring 32 and the first mounting portion 11 or the fourth mounting portion 314 through cooperation between the first hook protrusion 41 and the hook opening 322; and to ensure connection stability between the reset coil spring 32 and the second mounting portion 22 or the third mounting portion 313 through cooperation between the second hook protrusion 42 and the hook slot 324.

In addition, the present embodiment further includes a first mounting frame 5, a first connection insert sleeve 51 is rotatably arranged on the first mounting frame 5, and the first connection insert sleeve 51 is used for being inserted into the winding shaft 7 to rotate synchronously with the winding shaft 7. A linkage component 52 for linking the first connection insert sleeve 51 and the first mounting structure 1 is provided on the first mounting frame 5.

Specifically, the linkage component 52 is mounted in the first mounting frame 5. The linkage component 52 includes a first connection member 521, a linkage gear 523, and a second connection member 522. The first connection member 521 and the second connection member 522 are rotatably mounted to the first mounting frame 5 by passing through the first mounting frame 5. The linkage gear 523 is mounted to the first mounting frame 5 by means of an insert rod so as to be rotatably mounted to the first mounting frame 5. The first connection member 521 is provided with a first tooth 5211 in the first mounting frame 5, and the second connection member 522 is provided with a second tooth 5221 in the first mounting frame 5. The linkage gear 523 respectively meshes with the first tooth 5211 and the second tooth 5221 to achieve transmission. The first connection member 521 extends rightward out of the first mounting frame 5 and is fixedly mounted with the mounting rod 12 by means of latching, pins, or the like. The second connection member 522 extends rightward out of the first mounting frame 5 and is fixedly mounted with the first connection insert sleeve 51 by means of latching, pins, or the like, so that the first connection insert sleeve 51 and the first mounting structure 1 are located on the same horizontal side of the first mounting frame 5, wherein the first connection insert sleeve 51 is located below the first mounting structure 1.

Therefore, the first connection insert sleeve 51 linked with the first mounting structure 1 serves as a connection structure for the winding shaft 7, and the second mounting structure 2 is fixed. Thus, when the first connection insert sleeve 51 rotates with the winding shaft 7, the mounting rod 12 rotates under an action of the linkage component 52, thereby driving the first mounting portion 11 to rotate, achieving accumulating and releasing of elastic potential energy of the reset component 3 while the second mounting portion 22 is fixed.

Wherein, a plurality of first latching strips 511 are provided on the outer periphery of the first connection insert sleeve 51. The first latching strip 511 is in a strip shape extending along the left-right direction, and the first latching strips 511 are arranged at intervals along a circumferential direction of the first connection insert sleeve 51, so that when the first connection insert sleeve 51 and the winding shaft 7 are pluggably connected, circumferential positioning of the first connection insert sleeve 51 and the winding shaft 7 is achieved through the first latching strips 511.

### Embodiment 2

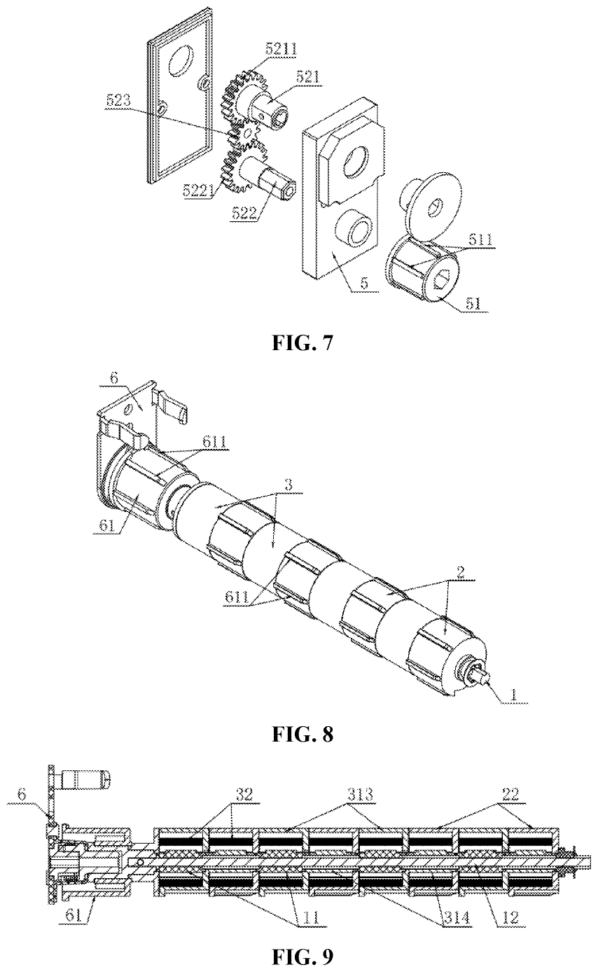

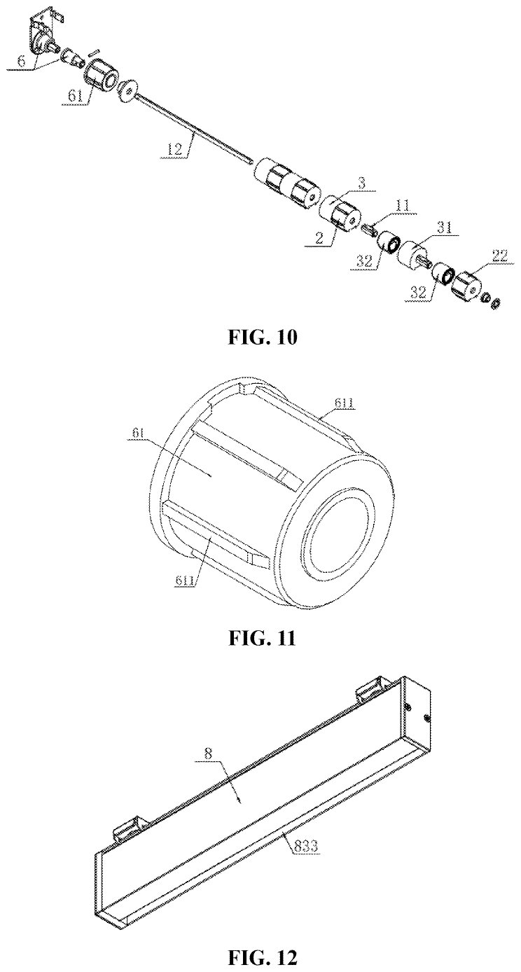

As shown in FIGS. 8 to 11, the present embodiment discloses a reset structure for roller blind. A main structure of the reset structure for roller blind is the same as that of Embodiment 1, and a difference lies in that the first mounting frame 5, the linkage component 52, and the first connection insert sleeve 51 are not provided, and instead:

The reset structure for roller blind further includes a second mounting frame 6, the first mounting structure 1 and the second mounting frame 6 are circumferentially fixedly connected. Specifically, the mounting rod 12 is inserted into the second mounting frame 6, and the mounting rod 12 and the second mounting frame 6 are relatively fixed by means of a pin or the like. The second mounting structure 2 is used for being inserted into the winding shaft 7 to rotate synchronously with the winding shaft 7.

In addition, a second connection insert sleeve 61 is rotatably mounted to the second mounting frame 6, and the second connection insert sleeve 61 is used for being inserted into the winding shaft 7 to rotate synchronously with the winding shaft 7.

Therefore, the second connection insert sleeve 61 and the second mounting portion 22 serve as a connection structure for the winding shaft 7, and the first mounting structure 1 is fixed. Thus, when the second mounting portion 22 rotates with the winding shaft 7, accumulating and releasing of elastic potential energy of the reset component 3 are achieved while the mounting rod 12 and the first mounting portion 11 are fixed.

Wherein, a plurality of second latching strips 611 are provided on an outer periphery of the second connection insert sleeve 61 and an outer periphery of the second mounting portion 22. The second latching strip 611 is in a strip shape extending along a left-right direction, and the second latching strips 611 are arranged at intervals along a circumferential direction of the second connection insert sleeve 61, so that when the second connection insert sleeve 61 and the winding shaft 7 are pluggably connected, circumferential positioning of the second connection insert sleeve 61 and the winding shaft 7 is achieved through the second latching strips 611, and when the second mounting portion 22 and the winding shaft 7 are pluggably connected, circumferential positioning of the second mounting portion 22 and the winding shaft 7 is achieved through the second latching strips 611.

### Embodiment 3

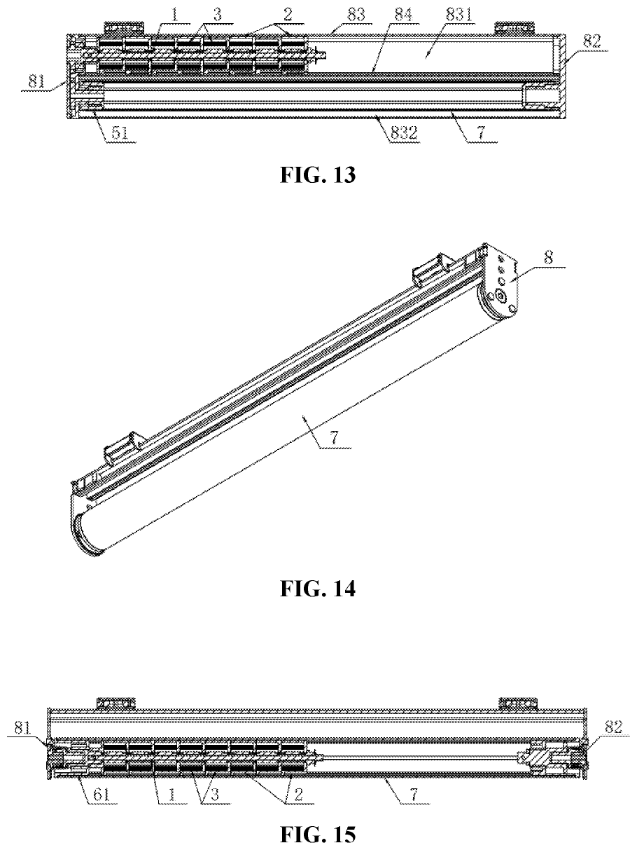

As shown in FIGS. 12 to 13, the present embodiment discloses a roller blind frame, comprising:
a winding shaft 7;
a first top rail 8, the first top rail 8 including a first mounting base 81 and a second mounting base 82 mounted at two axial ends of the winding shaft 7;
wherein the first mounting base 81 adopts the reset structure for roller blind in Embodiment 1. Specifically, the first connection insert sleeve 51 is inserted into one end of the winding shaft 7.

In addition, the first top rail 8 includes a top rail cover 83, the first mounting base 81 and the second mounting base 82 are provided at two ends of the top rail cover 83 and are fixedly mounted with the top rail cover 83 by means of bolts. The first mounting structure 1, the second mounting structure 2, the reset component 3, the first connection insert sleeve 51, and the winding shaft 7 are all provided in the top rail cover 83. A blind fabric opening 833 for the blind fabric 9 to extend out is provided at a bottom of the top rail cover 83,
so that the first mounting structure 1, the second mounting structure 2, the reset component 3, the first connection insert sleeve 51, and the winding shaft 7 are built in the top rail cover 83 to provide a protective effect.

Preferably, a regional partition plate 84 is fixedly mounted in the top rail cover 83 by means of bolts. The regional partition plate 84 divides an interior of the top rail cover 83 into a first region 831 at an upper side and a second region 832 at a lower side. The first mounting structure 1, the second mounting structure 2, and the reset component 3 are provided in the first region 831, and the winding shaft 7 is provided in the second region 832.

As such, the winding shaft 7 requiring the blind fabric 9 to enter and exit is provided in the second region 832 at the lower side to achieve smooth entry and exit of the blind fabric 9, while the first mounting structure 1, the second mounting structure 2, and the reset component 3 are provided in the closed first region 831 to provide a protective effect.

Preferably, an outer periphery shape of the second mounting portion 22 is adapted to a shape of the second region 832, so that the second mounting portion 22 is fixed by an outer periphery of the second mounting portion 22 abutting against a peripheral wall of the second region 832, making installation more convenient.

### Embodiment 4

As shown in FIGS. 14 to 15, the present embodiment discloses a roller blind frame, comprising:
a winding shaft 7;
a first top rail 8, the first top rail 8 including a first mounting base 81 and a second mounting base 82 mounted at two axial ends of the winding shaft 7;
wherein the first mounting base 81 adopts the reset structure for roller blind in Embodiment 2. Specifically, the second connection insert sleeve 61, the first mounting portion 11, the second mounting portion 22, and the reset component 3 are all inserted into the winding shaft from one end of the winding shaft 7.

As such, an internal space of the winding shaft 7 is utilized to make an overall structure more compact.

### Embodiment 5

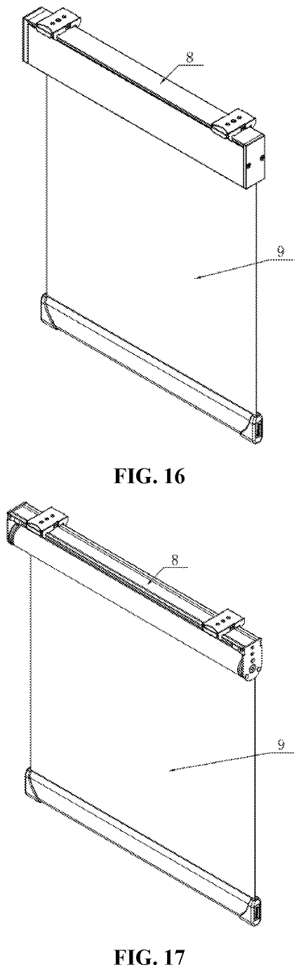

As shown in FIG. 16, the present embodiment discloses a roller blind device, comprising:
the roller blind frame of Embodiment 3;
a blind fabric 9, the blind fabric 9 being mounted on the winding shaft 7.

As such, when the blind fabric 9 is pulled downward, the reset component 3 accumulates elastic potential energy, and when the blind fabric 9 is released, the blind fabric 9 is automatically rewound under an action of the reset component 3.

### Embodiment 6

As shown in FIG. 17, the present embodiment discloses a roller blind device, comprising:
the roller blind frame of Embodiment 4;
a blind fabric 9, the blind fabric 9 being mounted on the winding shaft 7.

As such, when the blind fabric 9 is pulled downward, the reset component 3 accumulates elastic potential energy, and when the blind fabric 9 is released, the blind fabric 9 is automatically rewound under an action of the reset component 3.

What is claimed is:

1. A reset structure for roller blind, comprising:
a first mounting structure;
a second mounting structure, the first mounting structure and the second mounting structure being arranged for relative rotation; and
a reset component, the reset component being used for connecting the first mounting structure and the second mounting structure;
wherein the reset component includes a series connection members and b reset coil springs, each of the series connection members is arranged for relative rotation relative to the first mounting structure and the second mounting structure, wherein a and b are both positive integers, and a<b;
when a=1, at least one of the reset coil springs is used for connecting the first mounting structure and the series connection member, and at least one of the reset coil springs is used for connecting the second mounting structure and the series connection member;
when a>1, at least one of the reset coil springs is used for connecting the first mounting structure and one of the series connection members, at least one of the reset coil springs is used for connecting the second mounting structure and another one of the series connection members, and each of the series connection members is connected to at least another one of the series connection members via at least one of the reset coil springs.

2. The reset structure for roller blind according to claim 1, wherein: one of the first mounting structure and the second mounting structure is fixedly arranged, and another one is used for being arranged in linkage with a winding shaft; wherein, b=a+1.

3. The reset structure for roller blind according to claim 1, wherein: the first mounting structure includes a mounting rod and a first mounting portion disposed on the mounting rod, the series connection member includes a third mounting portion and a fourth mounting portion which are fixedly connected, the second mounting structure includes a second mounting portion, the first mounting portion is circumferentially fixedly arranged on the mounting rod, and the second mounting portion and the fourth mounting portion are both rotatably arranged with the mounting rod;
the third mounting portion is located at an outer periphery of the first mounting portion, one of the reset coil springs is sleeved on the outer periphery of the mounting rod, and an inner end of the reset coil spring is connected to the first mounting portion, and an outer end of the reset coil spring is connected to the third mounting portion located at the outer periphery of the first mounting portion;
the second mounting portion is located at the outer periphery of the fourth mounting portion, one of the reset coil springs is sleeved on the outer periphery of the mounting rod, and the outer end of the reset coil spring is connected to the second mounting portion, and the inner end of the reset coil spring is connected to the third mounting portion located at the outer periphery of the second mounting portion.

4. The reset structure for roller blind according to claim 3, wherein: the outer periphery of the mounting rod has a cylindrical shape, the outer periphery of the mounting rod is provided with a circumferential positioning slot, the circumferential positioning slot is disposed through along at least one axial end of the mounting rod,
at least one of the first mounting portion, the second mounting portion, and the fourth mounting portion is sleeved on the outer periphery of the mounting rod, and the first mounting portion is provided with a circumferential positioning protrusion matched in the circumferential positioning slot.

5. The reset structure for roller blind according to claim 3, wherein: the first mounting portion, the second mounting portion, the third mounting portion, and the fourth mounting portion each has a tubular shape, the first mounting portion and the fourth mounting portion are sleeved on the outer periphery of the mounting rod, the first mounting portion is located at an inner periphery of the third mounting portion, and the fourth mounting portion is located at the inner periphery of the second mounting portion.

6. The reset structure for roller blind according to claim 3, wherein: the first mounting portion and the fourth mounting portion are arranged in an axial direction of the mounting rod;
when a>1, the numbers of the first mounting portion, the second mounting portion, and the reset component are the same and all of which are at least two of pieces, each of the first mounting portions is arranged in the axial direction of the mounting rod, and each of the reset components is used for connecting different first mounting portions and the second mounting portions;
the inner end of the reset coil spring is provided with an inner mounting portion extending along a winding direction, the inner mounting portion is provided with a hook opening disposed through along a thickness direction, and an outer periphery of at least one of the first mounting portion and the fourth mounting portion is provided with a first hook protrusion inserted into the hook opening;
the outer end of the reset coil spring is provided with an outer mounting portion extending along a direction opposite to the winding direction, a U-shaped hook slot is disposed between the outer mounting portion and the reset coil spring, and an inner periphery of at least one of the second mounting portion and the third mounting portion is provided with a second hook protrusion inserted into the hook slot.

7. The reset structure for roller blind according to claim 2, further comprising a first mounting frame, a first connection insert sleeve being rotatably arranged on the first mounting frame, the first connection insert sleeve being used for being inserted into the winding shaft to rotate synchronously with the winding shaft; and
the first mounting frame is provided with a linkage component for linking the first connection insert sleeve and the first mounting structure.

8. The reset structure for roller blind according to claim 7, wherein: the linkage component includes a first connection member, a linkage gear, and a second connection member, the first connection member, the linkage gear, and the second connection member are respectively rotatably mounted on the first mounting frame, the first connection member is provided with a first tooth, the second connection member is provided with a second tooth, the linkage gear is meshed with the first tooth and the second tooth, the first mounting structure and the first connection member are circumferentially fixedly connected, and the first connection insert sleeve and the second connection member are circumferentially fixedly connected; the first connection insert sleeve and the first mounting structure are located on a same horizontal side of the first mounting frame, and the first connection insert sleeve is located below the first mounting structure.

9. The reset structure for roller blind according to claim 2, further comprising a second mounting frame, the first mounting structure and the second mounting frame being circumferentially fixedly connected; and
the second mounting structure is used for being inserted into the winding shaft to rotate synchronously with the winding shaft.

10. The reset structure for roller blind according to claim 9, wherein: a second connection insert sleeve is rotatably mounted on at least one of the second mounting frame and the first mounting structure, and the second connection insert sleeve is used for being inserted into the winding shaft to rotate synchronously with the winding shaft.

11. A roller blind frame, comprising:
a winding shaft;
a first top rail, the first top rail including a first mounting base and a second mounting base mounted at two axial ends of the winding shaft;
wherein at least one of the first mounting base and the second mounting base adopts or includes the reset structure for roller blind according to claim 1.

12. The roller blind frame according to claim 11, wherein: at least one of the first mounting base and the second mounting base adopts the reset structure for roller blind according to claim 7;
and the first connection insert sleeve is inserted into one end of the winding shaft.

13. The roller blind frame according to claim 12, wherein: the first top rail includes a top rail cover, the first mounting base and the second mounting base are disposed at two ends of the top rail cover, at least one of the first mounting structure, the second mounting structure, the reset component, the first connection insert sleeve, and the winding shaft is disposed in the top rail cover, and a bottom of the top rail cover is provided with a blind fabric opening for a blind fabric to extend out.

14. The roller blind frame according to claim 13, wherein: a regional partition plate is disposed in the top rail cover, the regional partition plate divides an interior of the top rail cover into a first region and a second region, the first mounting structure, the second mounting structure, and the reset component are disposed in the first region, and the winding shaft is disposed in the second region; and
the second mounting structure cooperates with the top rail cover such that the second mounting structure and the top rail cover are fixedly arranged.

15. The roller blind frame according to claim 11, wherein: at least one of the first mounting base and the second mounting base adopts the reset structure for roller blind according to claim 9; and
the first mounting structure, the second mounting structure, and the reset component are inserted into the winding shaft from one end of the winding shaft.

16. A roller blind device, comprising:
the roller blind frame according to claim 11; and
a blind fabric, the blind fabric being mounted on the winding shaft.
